(19) United States
(12) Patent Application Publication
(10) Pub. No.: US 2025/0236405 A1
(43) Pub. Date: Jul. 24, 2025

(54) ASSEMBLY COMPRISING A STATIONARY SURFACE AND A MOVABLE SURFACE OF AN AIRCRAFT

(71) Applicant: Safran Nacelles, Gonfreville L'Orcher (FR)

(72) Inventors: Fabien JOURDAN, Moissy Cramayel (FR); Philippe Wiertel, Moissy cramayel (FR); Laurent Georges Valleroy, Moissy Cramayel (FR)

(73) Assignee: Safran Nacelles, Gonfreville L'Orcher (FR)

(21) Appl. No.: 18/985,887

(22) Filed: Dec. 18, 2024

(30) Foreign Application Priority Data
Dec. 19, 2023 (FR) 23/14524

(51) Int. Cl. B64D 29/06

(52) U.S. Cl. CPC B64D 29/06

(57) ABSTRACT

An assembly for a propulsion unit including a stationary surface, a surface movable relative to the stationary surface, and a linking system to link the stationary surface and the movable surface and to allow the accommodation of a movement of the movable surface relative to the stationary surface. The linking system includes a linking device connected to the stationary surface, and a locking device connecting the linking device to the movable surface and including a fitting on which the linking device is mounted. The locking device, in an unlocking position, facilitates the displacement of the fitting relative to the movable surface during a movement of the movable surface relative to the stationary surface.

### CROSS-REFERENCE TO RELATED APPLICATIONS

This application claims priority to and the benefit of FR 23/14524 filed on Dec. 19, 2023. The disclosure of the above application is incorporated herein by reference.

### FIELD

The present disclosure relates to an assembly comprising a stationary surface, a surface movable relative to the stationary surface, and a linking system configured to link the stationary surface and the movable surface.

### BACKGROUND

The statements in this section merely provide background information related to the present disclosure and may not constitute prior art.

An aircraft propulsion unit generally comprises a turbomachine housed inside a nacelle.

The nacelle generally has a tubular structure comprising an air inlet upstream of the turbomachine, a middle section intended to surround a fan of the turbomachine and its casing, a downstream section intended to surround the combustion chamber of the turbomachine. It may be terminated by an ejection nozzle whose outlet is located downstream of the turbomachine.

The modern nacelles are intended to house a bypass turbomachine capable of generating, through the rotating fan blades, a stream of hot air (also called primary stream) coming from the combustion chamber of the turbomachine, and a stream of cold air (secondary stream) which circulates outside the turbomachine through an annular passage, also called a flow path, formed between a fairing of the turbomachine and an internal wall of the nacelle. The two air streams are ejected from the turbomachine through the rear of the nacelle.

The propulsion unit may, if desired, comprise a thrust reverser. The role of a thrust reverser is, when an aircraft is landing, to improve its braking capacity by redirecting forward at least part of the thrust generated by the turbomachine. In this phase, the reverser obstructs the flow path of the cold stream and directs the latter toward the front of the nacelle, thereby generating a counter-thrust which is added to the braking of the wheels of the aircraft.

The means implemented to carry out this reorientation of the cold stream vary depending on the type of inverter.

When the thrust reverser is a grid thrust reverser also known as a cascade reverser, the reorientation of the air stream is performed by cascade vanes. For example, the thrust reverser may have sliding grids. In this configuration, a structure with grids, for example sliding, may be housed on the fan casing of the turbomachine. The downstream section of the nacelle may be carried out in the form of two cowls movable in translation so as to be able to uncover the grids. These cowls are also mounted so as to be able to be opened “in a butterfly” fashion, then closed, by pivoting around a substantially longitudinal hinge line located near a pylon for linking to an aircraft, in particular for maintenance operations.

In order to provide a tangential positioning between the structure with grids housed on the fan casing and the cowls of the downstream section of the nacelle, a linking device may be disposed between these two structures.

During the first assembly of the propulsion unit, an incorrect positioning of the linking device between these two structures may lead to the introduction of parasitic forces. To date, the adjustment of the position of the linking device, for example during the first assembly, could only be done once the cowls are closed on the turbomachine, but in this configuration, access to the linking device would not be possible.

### SUMMARY

This section provides a general summary of the disclosure and is not a comprehensive disclosure of its full scope or all of its features.

The present disclosure aims in particular to overcome at least in part one of these drawbacks and concerns, according to a first aspect, an assembly, for example for a propulsion unit, for example of an aircraft comprising a stationary surface, such as a structure with grids for example connected to a fan casing of a turbomachine of the propulsion unit; a surface movable relative to the stationary surface, such as a movable cowl of a nacelle intended to surround the turbomachine, the surface may be movable at least according to one degree of freedom in rotation; a linking system configured to link the stationary surface and the movable surface and to allow the accommodation of a movement, for example a rotational movement of the movable surface relative to the stationary surface, and the linking system comprising: a linking device connected to the stationary surface and allowing the movement, for example a rotation of the movable surface relative to the stationary surface, and a locking device, for example forming a device for adjusting a position of the movable surface relative to the stationary surface, connecting the linking device to the movable surface, the locking device comprising a connecting element on which the linking device is mounted, the locking device is configured so as to in an unlocking position, allow the displacement of the connecting element relative to the movable surface, for example during a movement, for example a rotational movement, of the movable surface relative to the stationary surface, and in a locking position, inhibit the displacement of the connecting element relative to the movable surface.

Thus, the present disclosure relates to an assembly comprising a stationary surface, a surface movable relative to the stationary surface, and a linking system configured to link the stationary surface and the movable surface and to allow the accommodation of a movement of the movable surface relative to the stationary surface. The present disclosure also concerns a thrust reverser and an aircraft propulsion unit comprising such an assembly.

The locking device is configured to adjust the position of the movable surface relative to the stationary surface. The locking device is configured to allow fine adjustment of the position of the movable surface in the closed/locked state relative to the stationary surface in order to eliminate the forces in the stationary surface in the closed/locked state.

By means of such a locking device, it is possible to provide the correct positioning of the linking device between the stationary surface and the movable surface, in particular during the first assembly of the movable surface relative to the stationary surface, when the locking device is in the unlocking position, for example during a rotational movement of the movable surface relative to the stationary surface. This makes it possible to avoid the introduction of parasitic forces.

The locking device, forming for example a device for adjusting a position of the movable surface relative to the stationary surface, allows to finely adjust the position of the movable surface in the closed/locked state relative to the stationary surface, to eliminate the forces in the stationary surface in the locked state.

The assembly of the present disclosure includes one or more of the following optional characteristics.

The linking device is mounted on the movable surface by means of the locking device.

The locking device forms an interface between the linking device, for example a compass, and the movable surface.

The locking device comprises clamping means connecting the connecting element to the movable surface, the clamping means being configured so as to: in the unlocking position, allow the connecting element to be disengaged from the movable surface so as to allow the displacement of the connecting element relative to the movable surface during a movement, for example a rotational movement of the movable surface relative to the stationary surface, and in the locking position, maintain the connecting element engaged with the movable surface so as to inhibit the displacement of the connecting element relative to the movable surface.

The locking device comprises elastic means configured so as to, in the unlocking position, exert a force on the connecting element so as to disengage the connecting element from the movable surface, so as to allow the displacement of the connecting element relative to the movable surface during a movement, for example a rotational movement, of the movable surface relative to the stationary surface.

The elastic means comprise a spring leaf or at least one compression spring and are arranged at least partly between the connecting element and the movable surface.

The elastic means comprise at least one torsion spring and are arranged on the linking device.

The locking device is configured so as to, in the unlocking position, allow the displacement of the connecting element by translation relative to the movable surface during a movement, for example a rotational movement, of the movable surface relative to the stationary surface.

The connecting element comprises at least one recess, the at least one recess being configured to receive the clamping means and to allow a displacement of the connecting element relative to the clamping means during a rotational movement of the movable surface relative to the stationary surface, when the locking device is in the unlocking position, the clamping means being stationary relative to the movable surface when the locking device is in the unlocking position.

The clamping means comprise at least one cage nut and retaining means configured to maintain the at least one cage nut connected to the connecting element when the locking device is in the unlocking position.

The connecting element comprises first engagement means and the movable surface comprises second engagement means configured to cooperate with each other when the locking device is in the locking position, the first means and the second means comprising striations.

The connecting element may be a fitting.

The linking device may be a compass.

The movable surface is a movable cowl of a nacelle. The assembly further comprises a hinge arranged in a first part, for example an upper part, of the movable cowl, the hinge being configured to allow an opening of the movable cowl, for example for maintenance operations, the assembly further comprising a lock arranged in a second part, for example a lower part, of the movable cowl, the lock being configured to maintain the cowl closed, for example selectively. The second part is different from the first part.

The upper part and lower part are understood to mean the upper and lower parts of the cowl during normal use of the cowl, for example during normal use of a propulsion unit comprising the cowl.

For example, the hinge is circumferentially opposite the lock, for example relative to the cowl. The lock is distinct from the locking device. For example, the locking device is proximal to the hinge.

According to one aspect, the present disclosure relates to a thrust reverser of an aircraft propulsion unit, for example a thrust reverser with grids, for example with sliding grids, comprising the assembly as previously described. For example, the stationary surface may be a structure with grids, for example sliding grids, which may be connected to a fan casing of a turbomachine and the movable surface may be a movable cowl of a nacelle, for example a movable cowl of a downstream section of a nacelle, intended to surround the turbomachine.

For example, in the thrust reverser, the grids may be housed between the fan casing and a cowl of a middle section of the nacelle of the propulsion unit (e.g. a fan cowl), for example during maintenance operations or direct jet operation in which the grids are stationary. The grids may slide, for example translate with the movable cowl of the downstream section of the nacelle during reverse jet operation.

The present disclosure is particularly applicable to maintenance operations during which the structure with grids is stationary and the cowl of the downstream section of the nacelle is rotatably movable, so as to be able to be pivoted, for example relative to the structure with grids, during maintenance operations.

According to one aspect, the present disclosure relates to a propulsion unit comprising an assembly as previously described. The stationary surface may be a fan casing of a turbomachine of the propulsion unit and the movable surface may be a movable cowl of a nacelle intended to surround the turbomachine, for example a cowl of a middle section of the nacelle such as a fan cowl or of a downstream section of the nacelle such as a thrust reverser cowl. In one variant, the stationary surface may be an air inlet of the nacelle and the surface movable relative to the stationary surface may be a movable cowl of the nacelle, for example of a middle section of the nacelle, for example a fan cowl of the nacelle.

In one variant, the stationary surface may be a cowl of a middle section of the nacelle, for example a fan cowl, and the surface movable relative to the stationary surface may be a movable cowl of a downstream section of the nacelle, for example a thrust reverser cowl.

For example, the propulsion unit may comprise a nacelle, the nacelle including a movable cowl and the assembly as previously described, the movable cowl forming the surface movable relative to the stationary surface. The stationary surface may be a stationary surface of the propulsion unit.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an assembly according to the present disclosure in which a locking device is in the unlocked position and a movable surface is in the opening position;

FIG. 2 illustrates an assembly according to the present disclosure in which a locking device is in the unlocked position and the movable surface is in the closing position;

FIG. 3 illustrates an assembly according to the present disclosure in which a locking device is in the locked position and the movable surface is in the closing position;

FIG. 4 illustrates the assembly according to one variant of the present disclosure;

FIG. 5 illustrates the assembly according to one variant of the present disclosure;

FIG. 6 illustrates the assembly according to one variant of the present disclosure;

FIG. 7 is a perspective view of a propulsion unit comprising an assembly according to the present disclosure;

FIG. 8 is a perspective view of a thrust reverser comprising an assembly according to the present disclosure;

FIG. 9 is a perspective view of a thrust reverser comprising the assembly according to the present disclosure; and

FIG. 10 is a cross-sectional view of a propulsion unit according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

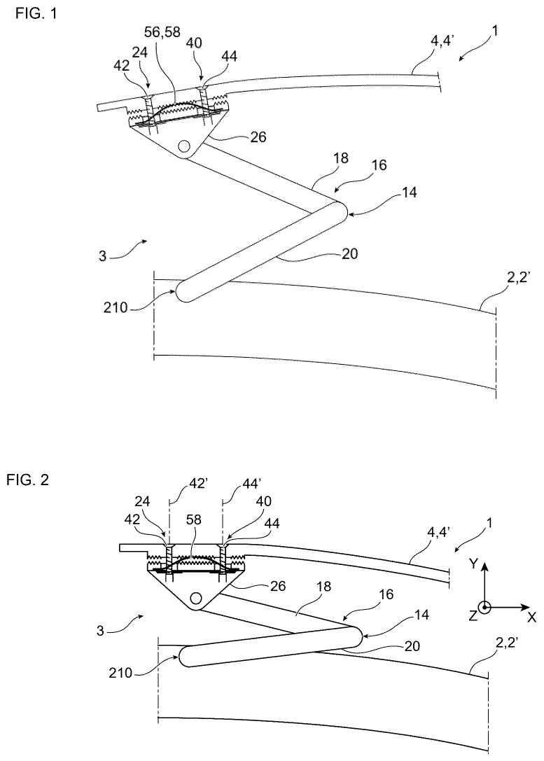

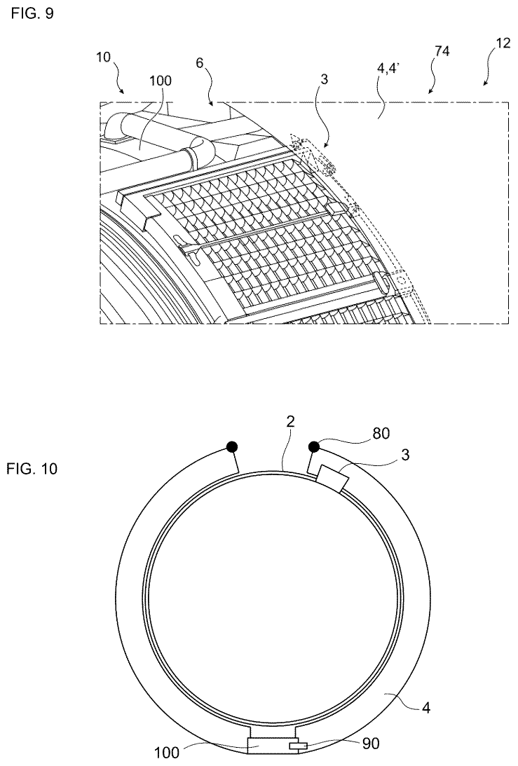

In the description and claims, the expressions “upper”, “above”, and “lower”, “below”, and their derivatives will be used without limitation in reference to the upper part and the lower part, respectively, of FIGS. 1 to 10.

In the remainder of the description of the assembly according to the present disclosure, the same numerical references designate the same elements.

FIGS. 1 to 6 illustrate an assembly 1 according to the present disclosure. An orthonormal reference frame XYZ is also represented in FIG. 2, the axis Z being perpendicular to the plane of FIG. 2.

The assembly 1 comprises a stationary surface 2, a surface 4 movable relative to the stationary surface 2, for example at least according to one degree of freedom in rotation, for example in rotation, and a linking system 3 linking the stationary surface 2 and the movable surface 4 and configured to allow the accommodation of a movement, for example rotational movement, of the movable surface 4 relative to the stationary surface 2.

The movable surface 4 may be pivotally mounted relative to the stationary surface 2. For example, the movable surface 4 may be rotatably movable, for example by pivoting, relative to the stationary surface 2.

The movable surface 4 may be rotatably movable, for example by pivoting, relative to the stationary surface 2 between a so-called opening or maintenance position (FIGS. 1 and 8) in which the movable surface 4 is distal to the stationary surface 2, and a closing or operating position (FIGS. 2, 3 and 6 and 9) in which the movable surface 4 is proximal to the stationary surface 2.

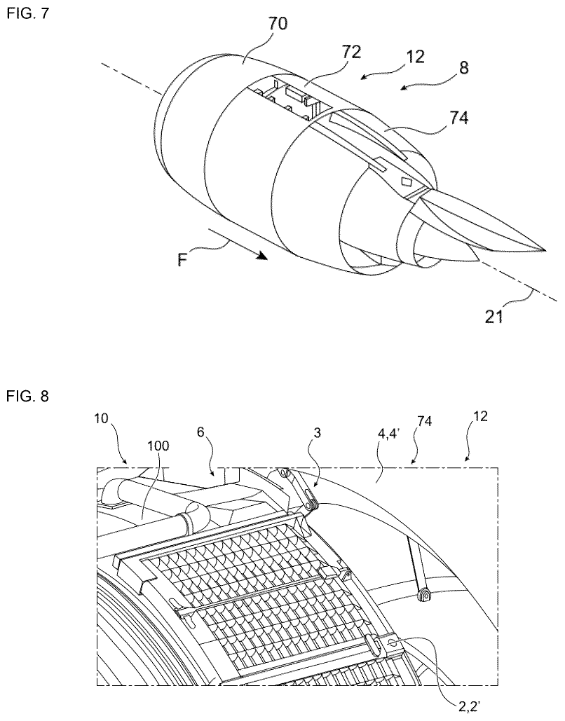

The stationary surface 2 and the movable surface 4 may be respectively a stationary surface and a movable surface of an aircraft, for example a stationary surface and a movable surface of an aircraft propulsion unit 8 (FIG. 7) comprising for example a turbomachine 10 and a nacelle 12, for example a stationary surface and a movable surface of a thrust reverser (FIG. 8) of a propulsion unit.

In the example illustrated in FIG. 8, the stationary surface 2 and the movable surface 4 may be respectively a stationary surface and a movable surface of a thrust reverser 6 of the aircraft propulsion unit.

The thrust reverser 6 which may be a reverser with grids, for example with sliding grids, may comprise thrust reverser means such as a structure with grids, for example with sliding grids, connected to a fan casing 100 of a turbomachine 10 and a movable cowl, for example movable relative to the structure with grids, such as a cowl of a downstream section 74 of the nacelle 12 (FIG. 7). In the present example, the thrust reverser 6 may comprise the assembly as previously described in which the stationary surface 2 may be the structure with grids, for example sliding 2′ which may be connected to the fan casing 100 of the turbomachine 10 and the movable surface 4 may be the movable cowl 4′ of the nacelle, for example of the downstream section 74 of the nacelle.

The movable surface 4, for example the pivoting cowl 4′, may be rotatably movable, for example in pivoting relative to the stationary surface 2, between the opening position (FIGS. 1, 8) in which the movable surface 4 may extend for example in a butterfly fashion relative to the stationary surface 2, so as to allow an access to the part of the turbomachine surrounded by the cowl, for example to an operator, and the closing position (FIGS. 2, 3 and 6) in which the movable surface 4 inhibits an access to the operator.

The movable surface 4, for example the pivoting cowl 4′, may be pivoted between the closing position and the opening position to allow an access to the turbomachine for maintenance operations for example.

Thus, according to a first aspect, the present disclosure concerns a thrust reverser 6, for example a thrust reverser with grids, for example with sliding grids comprising an assembly as previously described in which the movable surface may be a pivoting cowl 4′ of the thrust reverser, for example a pivoting cowl of a middle section of a nacelle intended to surround a turbomachine and the stationary surface may be a structure with grids, for example sliding, which may be connected to a fan casing 2′ of the turbomachine.

The assembly according to the present disclosure is not limited to the example which has just been described and may find other applications for example for a propulsion unit comprising a stationary surface and a surface movable relative to the stationary surface and which will be described subsequently.

In addition, other movements of the movable surface relative to the stationary surface may be envisaged, such as a translational movement for example, or even a movement combining rotation and translation.

The linking system 3 comprises a linking device 14 adapted to allow a relative movement between the two surfaces 2, 4.

The linking device 14 further allows the rotation, for example the pivoting of the movable surface 4 relative to the stationary surface 2. The linking device 14 may be for example an extendable or deployable device such as a jack, for example a ball-jointed jack or a compass. In the examples illustrated, but in a non-limiting manner, the linking device 14 which may be a compass 16, may comprise a first part, for example a first connecting rod 18, a first end of which is connected to the movable surface 4 and a second part, for example a second connecting rod 20, a first end of which is connected to the stationary surface 2, the first connecting rod 18 and the second connecting rod 20 may be hinged together so as to allow a relative movement between the movable surface 4 and the stationary surface 2. For example, the second ends of the connecting rods may be linked together by a pivot link.

The linking device 14, for example the second connecting rod 20 of the linking device 14, is connected to the stationary surface 2, for example directly connected to the stationary surface 2, for example by means of a pivot link 210 for example with an axis and yokes. Other connecting means may be envisaged such as a sliding pivot link or a ball joint.

The linking system 3 may comprise a locking device 24 connecting the linking device 14 to the movable surface 4. The locking device 24 may comprise a connecting element such as a fitting 26 on which the linking device 14 is mounted, for example the end of the first connecting rod 18 of the linking device 14. In this configuration, the locking device 24 may be configured so as to connect the linking device 14, for example the end of the first connecting rod 18 to the movable surface 4, through the fitting 26.

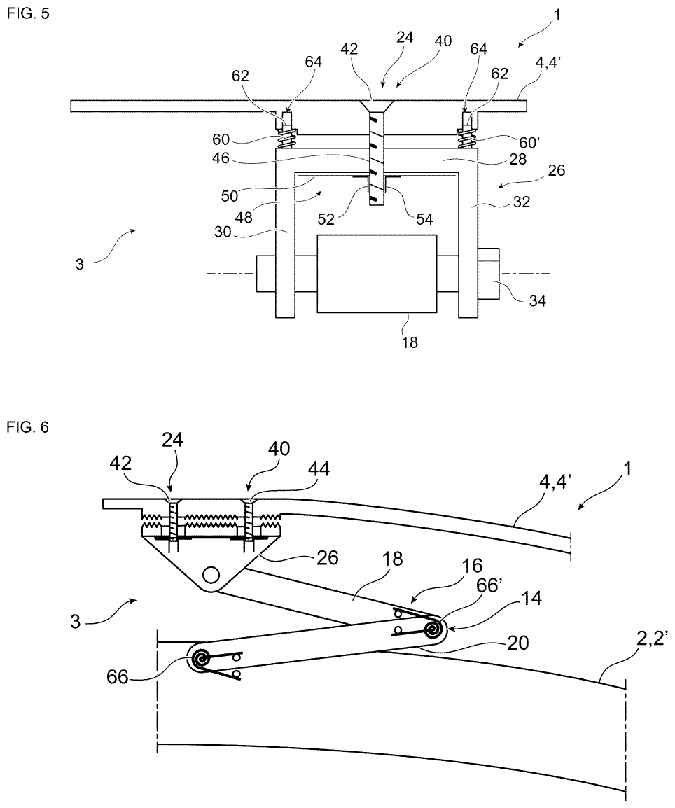

The fitting 26 may comprise a base 28 (FIG. 5) having a first face intended to be arranged facing a first face of the movable surface and a second face opposite the first face. The fitting 26 may comprise two lateral flanks 30, 32, for example triangular, which may extend from the base 28 and be substantially orthogonal to the base. The fitting 26 may for example comprise an arm 34 on which the end of the first connecting rod 18 may be mounted, for example in rotation, the arm being configured so as to allow a rotation of the end of the first connecting rod 18 of the linking device 14 relative to the arm 34. The arm 34 may extend into openings provided in the end of the first connecting rod 18 and in the lateral flanks 30, 32 of the fitting 26 (FIG. 5).

In this configuration, when the movable surface 4 is in the closing position (FIGS. 2, 3, 6), the linking device 14 is intended to guarantee a tangential positioning between the stationary surface 2 and the movable surface 4. When the movable surface 4 is driven, for example by pivoting relative to the stationary surface 2, towards the opening position (FIG. 1), for example for maintenance operations, the linking device 14 allows a relative movement between the two surfaces 2, 4.

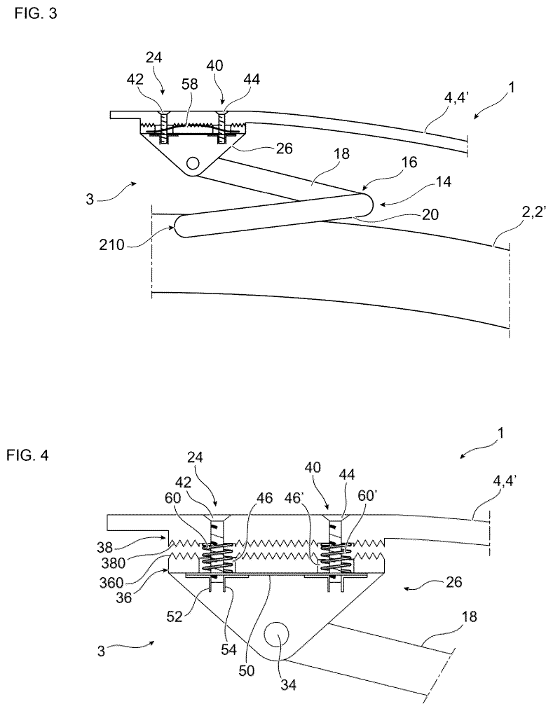

The locking device 24 may be configured so as to, in an unlocking position (FIGS. 1, 2, and 4 to 6), allow the displacement of the fitting 26 relative to the movable surface 4, for example during a rotational movement of the movable surface 4 relative to the stationary surface 2, and in a locking position (FIG. 3), inhibit the displacement of the fitting 26 relative to the movable surface 4.

In such a configuration, in the unlocking position, the rotational movement of the movable surface 4 relative to the stationary surface 2 causes the displacement of the fitting 26 relative to the movable surface 4.

By means of such a locking device, it is possible to provide the correct positioning of the linking device 14 between the stationary surface 2 and the movable surface 4, in particular during the first assembly of the movable surface 4 relative to the stationary surface 4, when the locking device is in the unlocking position, for example during a rotational movement of the movable surface 4 relative to the stationary surface 2, for example from the opening position to the closing position of the movable surface 4. This makes it possible to avoid the introduction of parasitic forces.

The locking system 3 allows an automatic adjustment of the positioning of the fitting 26 relative to the movable surface 4 and thus of the linking device 14 relative to the movable surface 4 and to the stationary surface 2. In the closing position of the movable surface, once the fitting 26 has been positioned adequately relative to the movable surface 4, it is possible to lock the locking device 24 (FIG. 3) so as to inhibit a subsequent displacement of the fitting 26 relative to the movable surface 4 and thus lock the positioning of the fitting 26 relative to the movable surface 4 and consequently the position of the linking device 14 between the movable surface 4 and the stationary surface 2.

Once the locking device is in the locking position, the movable surface 4 may subsequently be moved to the opening position (FIG. 1), for example for maintenance operations, by maintaining the locking device in the locking position so as to maintain the correct positioning of the linking device 14.

The locking device 24 may be configured so that in the unlocking position (FIGS. 1, 2 and 4 to 6), the fitting 26 may be disengaged from the movable surface 4 and may be maintained disengaged from the movable surface 4 so as to allow the displacement of the fitting 26 relative to the movable surface, for example during a rotational movement of the movable surface 4 relative to the stationary surface 2.

By disengaged from the movable surface, it is meant that the fitting 26 is not in contact with the movable surface 4.

The locking device 24 may be configured so that in the locking position (FIG. 3), the fitting 26 is engaged with the movable surface 4 and may be maintained engaged with the movable surface 4 so as to inhibit the displacement of the fitting 26 relative to the movable surface 4.

By engaged with the movable surface, it is meant that the fitting is in contact with the movable surface.

In this locking position (FIG. 3), in particular when the movable surface is in the closing position, the engagement of the fitting 26 and of the movable surface 4 allows a transmission of force.

For this purpose, the fitting 26 may comprise first engagement means 36 and the movable surface 4 may comprise second engagement means 38 (FIG. 4) configured to cooperate with each other when the locking device 24 is in the locking position and the fitting 26 is engaged with the movable surface 4 (FIG. 3). The first and second engagement means 36, 38 may comprise striations 360, 380 configured to cooperate with each other when the locking device 24 is in the locking position. For example, the first engagement means 36 may be arranged on the first face of the base 28 of the fitting 26 and the second engagement means 38 may be arranged on a part of a first face of the movable surface 4 intended to engage with the fitting 26. This configuration allows a significant force transmission, when in the locking position, the fitting 26 is engaged with the movable surface 4.

According to one variant, for example in the case of a transmission of low forces, the first and second engagement means 36, 38 may comprise a smooth surface, the fitting 26 and the movable surface 4 then being able to be engaged by adhesion or friction or via bonding means such as glue or an adhesive film, for example double-sided, disposed on the fitting 26 or the movable surface 4.

The first engagement means and the second engagement means 36, 38 may be formed in one piece, respectively with the fitting 26 and the movable surface 4.

The locking device 24 may comprise clamping means 40 connecting the fitting 26 to the movable surface 4.

The clamping means 40 may be configured so as to, in the unlocking position (FIGS. 1, 2 and 5 to 6), allow the fitting 26 to be disengaged from the movable surface so as to allow the displacement of the fitting 26 relative to the movable surface 4, for example during a rotational movement of the movable surface relative to the stationary surface, and in the locking position (FIG. 3), to engage the fitting 26 with the movable surface 4 and to maintain the fitting 26 engaged with the movable surface 4 so as to inhibit the displacement of the fitting 26 relative to the movable surface 4.

For example, the clamping means 40 may be configured so as to, in the unlocking position (FIGS. 1, 2 and 5 to 6), disengage the fitting 26 from the movable surface 4 so as to allow the displacement of the fitting 26 relative to the movable surface 4.

The clamping means 40 may be movable, for example in rotation, between a first position corresponding to the unlocking position of the locking device and a second position corresponding to the locking position of the locking device.

The clamping means 40 may be configured to be driven from the unlocking position to the locking position so as to bring the fitting closer to the movable surface and engage the fitting 26 with the movable surface 4, for example by pressing the fitting 26 and the movable surface 4, and to be driven from the locking position to the unlocking position so as to allow the fitting 26 to be disengaged from the movable surface 4, for example so as to disengage the fitting 26 from the movable surface 4.

The clamping means 40 may be configured to be driven between the locking position and the unlocking position by screwing/unscrewing. For example, the clamping means 40 may be screwed so as to be driven into the locking position and may be unscrewed so as to be driven into the unlocking position.

The clamping means 40 may be configured so as to be driven between the locking and unlocking positions, for example by an operator, for example from the external face of the movable surface 4, that is to say the face opposite the face intended to be engaged with the fitting 26 in the locking position.

This configuration makes it possible to lock the locking device when the locking device is only accessible from one side. In the illustrated examples, the clamping means 40 may comprise at least one cage nut 42, 44, for example two cage nuts 42, 44.

The clamping means 40 may comprise a portion extending through the movable surface 4, for example in a through housing formed in the movable surface, for example in a through hole formed in the movable surface 4 and emerging onto the external surface of the movable surface to allow their access (particularly visible in FIG. 5).

When the clamping means are driven between the locking position and the unlocking position, the fitting 26 is configured to move relative to the clamping means 40, for example relative to a second portion of the clamping means, by translation, for example along an axis parallel to an axis 42′, 44′ of the clamping means, for example the rotation axis 42′, 44′ of the clamping means. The fitting 26 is configured to move relative to the clamping means, for example along the axis Y of the orthonormal reference frame (FIG. 2) when the clamping means 40 are driven between the locking position and the unlocking position.

For this purpose, the fitting 26 may have at least one recess 46, the at least one recess 46 being configured to receive the clamping means and to allow a displacement of the fitting 26 relative to the clamping means, for example by translation along the axis Y when the clamping means are driven between the locking position and the unlocking position. In the illustrated examples, two recesses 46, 46′ (FIG. 4) are formed in the fitting so as to each receive a clamping means 42, 44, for example a cage nut.

The locking device 24 may comprise retaining means 48 configured to maintain the clamping means 40 and the fitting connected when the locking device is in the unlocking position and for example the clamping means 40 are unscrewed. In the illustrated examples, this configuration makes it possible to maintain the connection between the fitting 26 and the clamping means 40 and to inhibit the fitting 26 from becoming detached from the clamping means 40, while allowing the fitting 26 to move relative to the movable surface 4.

In the illustrated examples, the retaining means 48 may comprise a plate 50 which may extend under the second face of the base 28 of the fitting 26 (FIG. 5) and which may have two openings (not visible) in which the clamping means 40 are engaged, for example each cage nut 42, 44. The retaining means 48 may comprise fastening means 52, 54 configured to fasten the clamping means 40 to the plate 50, for example two screens respectively fastening each cage nut 42, 44 to the plate 50.

In the unlocking position, the fitting 26 and the movable surface 4 may be maintained disengaged from each other manually, for example by pressing on the nuts 42, 44.

In one variant, the locking device 24 may comprise elastic means 56 configured so as to, in the unlocking position (FIGS. 1, 2 and 4 to 6), exert a force on the fitting 26 so as to disengage the fitting 26 from the movable surface 4 and to maintain the fitting 26 disengaged from the movable surface 4.

This configuration is particularly advantageous, to provide a disengagement of the fitting 26 and of the movable surface 4 when the locking device 24 is in the unlocking position, for example when the fitting 26 and the movable surface 4 comprise striations 360, 380.

Furthermore, these elastic means 56 may be configured so as to allow the fitting 26 to be engaged with the movable surface 4, when the locking device is in the locking position. For example, the elastic means 56 may be configured so that the force that they apply to the fitting 26 is less than the tensile force applied by the clamping means 40 to the fitting 26 when the locking device is in the locking position.

In a first example illustrated in FIGS. 1 to 3, the elastic means 56 may comprise a spring leaf 58 which may extend at least partly between the fitting 26 and the movable surface 4.

In a second example illustrated in FIGS. 4 and 5, the elastic means 56 may comprise at least one compression spring 60, for example two compression springs 60, 60′.

In a first variant illustrated in FIG. 4, each compression spring 60, 60′ may be arranged around one of the clamping means 40, for example around one of the cage nuts 42, 44, and may comprise a part connected to the fitting 26 and a part connected to the movable surface 4. In a second variant illustrated in FIG. 5, the fitting 26 may comprise pins 62, for example two pins 62 extending from the first face of the base 28 of the fitting 26 and configured to each engage, for example in the locking position, in a groove 64, for example one of the two grooves formed in the movable surface 4. Each compression spring 60, 60′ may be arranged around one of the pins 62 of the fitting 26 and may comprise a part connected to the fitting 26 and a part connected to the movable surface. Alternatively, the movable surface 4 may comprise the pins, and the fitting 26 may have the grooves.

In a third example illustrated in FIG. 6, the elastic means 56 may comprise at least one torsion spring 66 and may be arranged on the linking device 14, for example on the second connecting rod 20 of the linking device 14. In the example illustrated in FIG. 5, the elastic means 56 comprise two torsion springs 66, 66′, arranged on the second connecting rod 20 of the linking device 14, on each of the ends of the second connecting rod 20 of the linking device 14. The first torsion spring 66 may comprise an end connected to a first end of the second connecting rod 20 and an end connected to the stationary surface 2, and the second torsion spring 66′ may comprise an end connected to the second end of the second connecting rod 20 and an end connected to the first connecting rod 18.

The elastic means 56 may be configured so that they may be dismantled, for example once the position of the fitting 26 relative to the movable surface 4 has been adjusted. This allows a saving in mass.

The locking device 24 is configured so as to, in the unlocking position, allow the displacement of the fitting 26 by translation relative to the movable surface 4, for example during a rotational movement of the movable surface relative to the stationary surface. For example, the locking device 24 is configured so as to, in the unlocking position, allow the displacement of the fitting 26 by translation along the axis X of the orthonormal reference frame (FIG. 2) relative to the movable surface 4, for example during a rotational movement of the movable surface relative to the stationary surface.

For example, each recess 46, 46′ of the fitting 26, which is configured to receive the clamping means, may be configured so as to allow a displacement of the fitting 26 relative to the clamping means, and therefore relative to the movable surface, the clamping means being stationary relative to the movable surface in the unlocking position.

In the illustrated examples, when the locking device is in the unlocking position, the clamping means 40 as well as the retaining means comprising the plate 50 and the fastening means 52, 54 are stationary relative to the movable surface 4, for example during a rotational movement of the movable surface relative to the stationary surface.

The recesses 46, 46′ provided in the fitting 26 are sized, for example form a space authorizing, for example allowing a displacement of the fitting 26 relative to the clamping means 40 and to the movable surface 4, for example by translation along an axis orthogonal to the axis of the clamping means, for example along the axis X of the orthonormal reference frame (FIG. 2), when the locking device is in the unlocking position.

This configuration may be advantageous when the linking device 14 comprises two connecting rods 18, 20 hinged as in the illustrated examples. The locking device 24 could be configured so as to, in the unlocking position, allow the displacement of the fitting by translation along two axes, for example along the axis X and the axis Z of the orthonormal reference frame (FIG. 2).

The locking device 24 may be configured so as to, in the unlocking position, allow the displacement of the fitting 26 relative to the movable surface 4 according to one or two degrees of freedom in translation, for example according to axes distinct from the axes of the clamping means 40.

The displacement of the fitting 26 may be limited by the distance between the walls delimiting each of the recesses 46, 46′ of the fitting 26. The fitting 26 may for example be moved, for example by translation relative to the movable surface, until the clamping means come into abutment against one of the walls delimiting the recesses 46, 46′.

The operation of the assembly 1 is described and may correspond for example to the first assembly of the assembly 1 for example to the first assembly of the movable surface 4.

As illustrated in FIG. 1, the movable surface 4 may be in an opening position, that is to say a position in which the movable surface 4 is distal to the stationary surface 2. The locking device is in an unlocking position so as to allow the fitting 26 to be able to move relative to the movable surface 4, for example during a rotation of the movable surface relative to the stationary surface from the opening position (FIG. 1) to the closing position (FIG. 2).

In the unlocking position, the clamping means 40, 42, 44 are unscrewed and the fitting 26 is disengaged and maintained disengaged from the movable surface 4, for example via the elastic means 56.

The movable surface 4 may be rotated relative to the stationary surface 2 between the opening position (FIG. 1) and the closing position (FIG. 2). During this movement, the fitting 26 moves by itself relative to the stationary surface, so that once the movable surface is in the closing position, the fitting 26 has positioned itself correctly relative to the movable surface. This provides the correct positioning of the linking device between the movable surface and the stationary surface.

Once the movable surface 4 is in the closing position (FIG. 2), the locking device may be driven into the locking position (FIG. 3), for example by screwing the clamping means 40 so as to engage the fitting 26 with the movable surface 4 and maintain the fitting engaged with the movable surface. In the locking position, the fitting may no longer move relative to the movable surface, the locking position allows the fitting to be locked in the appropriate position. The locking device is configured so as to allow a locking from an external surface of the movable surface, the only face accessible to an operator when the movable surface is in the closing position.

Once the locking device is locked with the fitting 26 and thus the linking device 14 is adjusted in the correct position, the movable surface 4 which may be an example the cowl may then be fastened, to another movable surface, for example to another cowl, for example by means of bolts. In this configuration, the engagement of the fitting and of the movable surface allows a transmission of force.

In subsequent operations, the movable surface 4 can, for example once detached from the other movable surface, be driven again into the opening position, for example for maintenance operations, the locking device being maintained locked to provide that the correct position of the linking device is maintained.

The linking system according to the present disclosure makes it possible to customize the adjustment of the position of the linking device, in fact, the positioning of the cowls relative to the fan casing supporting the grid structure may differ from one cowl and from one turbomachine to another.

The present disclosure may be applied to any assembly, for example any propulsion unit, comprising a stationary surface, a surface movable relative to the stationary surface for example by pivoting and a linking device between the two surfaces, to provide a good positioning of the linking device during the assembly of the movable surface relative to the stationary surface, the relative positioning of which may be hazardous. Thanks to the present disclosure, the positioning may be done blindly.

According to one aspect, the present disclosure relates to a propulsion unit comprising an assembly as previously described. The propulsion unit may comprise the thrust reverser 6 as previously described.

The propulsion unit is illustrated in FIG. 7 and comprises a turbomachine 10 (FIG. 8) and a nacelle 12 surrounding the turbomachine 10 and the assembly 1 as previously described (not visible). The turbomachine 10 may comprise an upstream section comprising a fan casing 2′ surrounding blades of a fan and a downstream section comprising a combustion chamber.

The nacelle 12 may comprise an upstream section 70 corresponding to an air inlet of the nacelle, a middle section 72 intended to surround the fan of the turbomachine and comprising a fan cowl, a downstream section 74 housing thrust reversal means and intended to surround the combustion chamber of the turbomachine, the upstream and downstream of the nacelle being defined by reference to the direction of flow of the air stream F in the nacelle, the upstream corresponding to a part of the nacelle through which the air stream enters and the downstream corresponding to an ejection area of the air stream. The nacelle may be terminated by an ejection nozzle whose outlet is located downstream of the turbomachine.

The nacelle may be a D-duct type nacelle, that is to say the downstream section of which is carried out in the form of two cowls, movable in translation so as to uncover the cascade vanes. These cowls 4′ are also mounted so as to be able to be opened “butterfly” fashion, that is to say pivotally mounted, in particular during maintenance operations, then closed, by pivoting around a substantially longitudinal hinge line located near a pylon for linking to an aircraft. According to one example, the movable surface may be a movable cowl of the downstream section of the nacelle and the stationary surface may be a stationary surface of the propulsion unit, for example the structure with grids of the thrust reverser. The assembly may comprise a hinge 80, arranged for example in the upper part of the movable cowl and configured to allow the cowl to be opened, for example for maintenance operations (FIG. 10). The cowls may be rotatably movable along an axis substantially colinear with the longitudinal axis 21 of the propulsion unit. The assembly may also comprise a lock 90, arranged for example in the lower part of the movable cowl and carrying out for example a tangential clamping between the cowl 4 and a beam 100 of the assembly 1 or of the propulsion unit 7 in order to maintain the cowl closed/locked.

In another example, the stationary surface may be the structure with grids of the thrust reverser and the movable surface may be a pivoting cowl of the middle section of the nacelle such as a fan cowl.

In another example, the stationary surface may be the fan casing of the turbomachine and the surface movable relative to the stationary surface may be a movable cowl of a middle section 72 of the nacelle, for example a fan cowl, or a movable cowl of a downstream section 74 of the nacelle, for example a thrust reverser cowl.

In another example, the stationary surface 2 may be, for example, the air inlet 70 of the nacelle and the surface 4 movable relative to the stationary surface may be a middle section movable cowl 72 of the nacelle, for example the fan cowl.

In another example, the stationary surface 2 may be, for example, a movable cowl of a middle section 72 of the nacelle, for example a fan cowl, and the surface 4 movable relative to the stationary surface may be a cowl of a downstream section 74 of the nacelle, for example a cowl of a thrust reverser. In this example, the thrust reverser cowl may be movable, for example in rotation, for example in pivoting relative to the fan cowl, so as to be able to open the thrust reverser cowl for maintenance operations. The nacelle of the propulsion unit may comprise the assembly as previously described.

As illustrated in FIG. 10, the assembly may further comprise the hinge 80 arranged for example in a first part, for example an upper part, of the movable cowl, forming for example the movable surface of the assembly 1, the hinge 80 being configured to allow the opening of the movable cowl, for example for maintenance operations. For example, the hinge is arranged at a first circumferential end of the movable cowl. The movable cowl 4 may be movable relative to a stationary structure of the propulsion unit forming for example the stationary surface of the assembly 1. The assembly 1 further comprises the lock 90 arranged in a second part, for example a lower part, of the movable cowl, the lock 90 being configured to maintain the cowl closed, for example selectively. For example, the lock is arranged at the other circumferential end of the movable cowl.

The upper part and lower part are understood to mean the upper and lower parts of the cowl during normal use of the cowl, for example during normal use of a propulsion unit comprising the cowl. The second part is different from the first part.

For example, the hinge 80 is circumferentially opposite the lock 90, for example relative to the cowl 4. The lock 90 is distinct from the locking device 24 of the linking system. For example, the linking system 3 is proximal to the hinge 80.

For example, the locking device of the linking system 3 is proximal to the hinge 80. Such a configuration may, for example, also apply to the second cowl illustrated in FIG. 10.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An assembly for an aircraft propulsion unit, comprising:
a stationary surface;
a movable surface that is movable relative to the stationary surface and configured to surround a turbomachine of the aircraft propulsion unit; and
a linking system configured to link the stationary surface and the movable surface and configured to accommodate a movement of the movable surface relative to the stationary surface, the linking system comprising:
a linking device connected to the stationary surface and configured to facilitate the movement of the movable surface relative to the stationary surface, and
a locking device configured to adjust a position of the movable surface relative to the stationary surface, the locking device connects the linking device to the movable surface, the locking device comprising a connecting element on which the linking device is mounted,
wherein the locking device is configured, in an unlocking position, to allow a displacement of the connecting element relative to the movable surface during a movement of the movable surface relative to the stationary surface, and, in a locking position, to inhibit the displacement of the connecting element relative to the movable surface.

2. The assembly according to claim 1 wherein the movable surface is movable according to at least one degree of freedom in rotation relative to the stationary surface.

3. The assembly according to claim 1, wherein the locking device further comprises a clamping device that connects the connecting element to the movable surface, the clamping device configured to:
in the unlocking position, allow the connecting element to be disengaged from the movable surface to allow the displacement of the connecting element relative to the movable surface during a movement of the movable surface relative to the stationary surface, and
in the locking position, maintain the connecting element engaged with the movable surface to inhibit the displacement of the connecting element relative to the movable surface.

4. The assembly according to claim 3 wherein the locking device further comprises a retaining device configured to maintain the clamping device and the connecting element connected when the locking device is in the unlocking position.

5. The assembly according to claim 1, wherein the locking device comprises an elastic device configured to, in the unlocking position, exert a force on the connecting element to disengage the connecting element from the movable surface to allow the displacement of the connecting element relative to the movable surface during a movement of the movable surface relative to the stationary surface.

6. The assembly according to claim 1, wherein the linking device is a compass.

7. The assembly according to claim 1, wherein the locking device is configured to, in the unlocking position, allow the displacement of the connecting element by translation relative to the movable surface during a movement of the movable surface relative to the stationary surface.

8. The assembly according to claim 1, wherein the connecting element comprises a first engagement device and the movable surface comprises a second engagement device configured to cooperate with each other when the locking device is in the locking position, and the first engagement device and the second engagement device comprise striations.

9. The assembly according to claim 1, wherein the movable surface is a movable cowl of a nacelle, and the assembly further comprises a hinge arranged in a first part of the movable cowl, the hinge configured to allow an opening of the movable cowl for maintenance operations, the assembly further comprising a lock arranged in a second part of the movable cowl, the lock configured to selectively maintain the movable cowl closed.

10. A propulsion unit comprising a nacelle, and an assembly according to claim 1, wherein the nacelle comprises a movable cowl, the movable cowl forming the movable surface movable relative to the stationary surface.
